(19) United States
(12) Patent Application Publication
(10) Pub. No.: US 2016/0190879 A1
(43) Pub. Date: Jun. 30, 2016

(54) INTERIOR-PERMANENT-MAGNET MOTOR STRUCTURE

(71) Applicant: HIWIN MIKROSYSTEM CORP., Taichung City (TW)

(72) Inventors: Li-Wei ZHENG, TAICHUNG CITY (TW); Ping-Shiun LU, TAICHUNG CITY (TW); Wei-Ping LIN, TAICHUNG CITY (TW)

(21) Appl. No.: 14/586,855

(22) Filed: Dec. 30, 2014

(51) Int. Cl. H02K 1/27; H02K 3/00

(52) U.S. Cl. CPC H02K 1/276; H02K 3/00

(57) ABSTRACT

An interior-permanent-magnet motor structure includes an air gap having the form of an annular band. The air gap is positioned between the stator and the rotor. The width of the annular band of the air gap has a maximum value and a minimum value within each pole pitch range. Accordingly, the air gap magnetic flux is nearly in sine wave state.

### BACKGROUND OF THE INVENTION

1. Field of the Invention

The present invention relates generally to a motor, and more particularly to an improved interior-permanent-magnet motor structure.

2. Description of the Related Art

In an interior-permanent-magnet motor, the permanent magnets are embedded in the iron core of the rotor and enclosed by the iron core. Therefore, the interior-permanent-magnet motor has better mechanical reliability and is suitable for high-speed operation. FIG. 1 shows an improved conventional interior-permanent-magnet motor having higher performance. In the interior-permanent-magnet motor, voids are formed between the magnetic bodies la of two poles in the rotor and two sides of outer circumference of the rotor so as to avoid magnetic short-circuit effect. Also, the voids serve to enhance the rotational torque and reduce cogging force so as to achieve damping and noise-lowering effect.

The spaces of the voids 1b provide magnetic resistance different from the iron core of the rotor so as to adjust the magnetic flux density distribution between the stator and the rotor, whereby the interior-permanent-magnet motor can have better operation state. FIG. 2 shows another conventional interior-permanent-magnet motor similar to the above interior-permanent-magnet motor. The interior-permanent-magnet motor of FIG. 2 has a noncircular rotor 2a. The rotor has a notched hollow section between two poles as a space for avoiding magnetic short-circuit.

FIG. 3 shows still another conventional interior-permanent-magnet motor. In this interior-permanent-magnet motor, the noncircular rotor 3a has a notch 3b. The magnetic bodies 3c are embedded in the noncircular rotor 3a. An angle θ2 is contained between the adjacent magnetic bodies 3c, while an angle θ4 is contained between the adjacent notches 3b. FIG. 4 shows the relationship between the ratio of θ2 to θ4 and the efficiency of the motor. In the case that the rotor has a circular configuration without any notch, the ratio of θ2 to θ4 is 100%. Under such circumstance, the operation performance of the motor is poor and unstable. After the magnetic flux is adjusted by the notches 3b, a better performance is achieved and the operation state of the motor is stabilized. However, it can be known from the curve of FIG. 4 that the enhancement of the performance of the motor is still limited. Even in an optimized state, the performance of the motor is simply increased from 1 per unit value to 1.02 per unit value. Also, the reduction of the cogging force is limited.

### SUMMARY OF THE INVENTION

It is therefore a primary object of the present invention to provide an improved interior-permanent-magnet motor structure in which the air gap magnetic flux is nearly in the optimal sine wave state. Accordingly, the cogging force effect of the interior-permanent-magnet motor is apparently improved and the interior-permanent-magnet motor can more smoothly operate.

To achieve the above and other objects, the interior-permanent-magnet motor structure of the present invention includes an air gap having the form of an annular band. The air gap is positioned between the stator and the rotor. The width of the annular band of the air gap has a maximum value and a minimum value within each pole pitch range. Accordingly, the air gap magnetic flux is nearly in sine wave state.

To speak more specifically, the interior-permanent-magnet motor structure of the present invention includes: a rotor member having a rotor seat, multiple magnetic bodies being embedded in the rotor seat in pair, the magnetic bodies being arranged in V-form, an opening of the V-form being positioned with its back to a curvature center of the rotor seat; a stator member having a hollow stator seat, the stator seat being coaxially fitted around the rotor seat; and an air gap having the form of an annular band. The air gap is positioned between inner circumference of the stator seat and outer circumference of the rotor seat. The interior-permanent-magnet motor structure is characterized in that the width of the annular band of the air gap has a maximum value and a minimum value within each pole pitch. The ratio of the maximum value to the minimum value meets the following formula: gₘᵢₙ÷g=cos(b÷a×θ), wherein: gₘᵢₙ the minimum value of the width of the annular band of the air gap, g is the maximum value of the width of the annular band of the air gap, a is the magnetic flare angle, b is the pole pitch, and θ is −π÷2˜+π÷2.

In the above interior-permanent-magnet motor structure, the change of the width of the annular band of the air gap is achieved by means of changing the configuration of one side end face of the air gap. In other words, the arc faces of the outer circumference of the rotor seat corresponding to the respective pole pitch ranges have respective curvature centers. The curvature centers of the arc faces are different from the curvature center of the rotor seat. Therefore, relative to the circular face centered at the curvature center of the rotor seat, the respective arc faces of the outer circumference of the rotor seat are in the form of protuberances, whereby the width of the annular band of the air gap is varied.

In the above interior-permanent-magnet motor structure, the curvature centers of the respective arc faces are positioned between the curvature center of the rotor seat and the arc faces.

In the above interior-permanent-magnet motor structure, the curvature center of the inner circumference of the stator seat is coaxial with the curvature center of the rotor seat.

In the above interior-permanent-magnet motor structure, the minimum width of the annular band of the air gap within each pole pitch range is positioned at the center of the belonging pole pitch.

In the above interior-permanent-magnet motor structure, the magnetic flare angle is the angle defined by two points of a pair of magnetic bodies that are spaced from each other by a largest distance and the curvature center of the rotor seat as an original point.

In the above interior-permanent-magnet motor structure, the rotor member further includes multiple insertion cavities respectively disposed in the rotor seat in pair and the multiple magnetic bodies are respectively inlaid in the insertion cavities in pair.

In the above interior-permanent-magnet motor structure, each insertion cavity has a capacity larger than a volume of the magnetic body inlaid in the insertion cavity.

In the above interior-permanent-magnet motor structure, each insertion cavity has an elongated cross section and the walls of two ends of the insertion cavity are spaced from two ends of the magnetic body inlaid in the insertion cavity.

In the above interior-permanent-magnet motor structure, the stator member further includes multiple distributed windings respectively wound on the stator seat.

The present invention can be best understood through the following description and accompanying drawings, wherein:

### BRIEF DESCRIPTION OF THE DRAWINGS

FIG. 1 is a sectional view of a conventional interior-permanent-magnet motor;

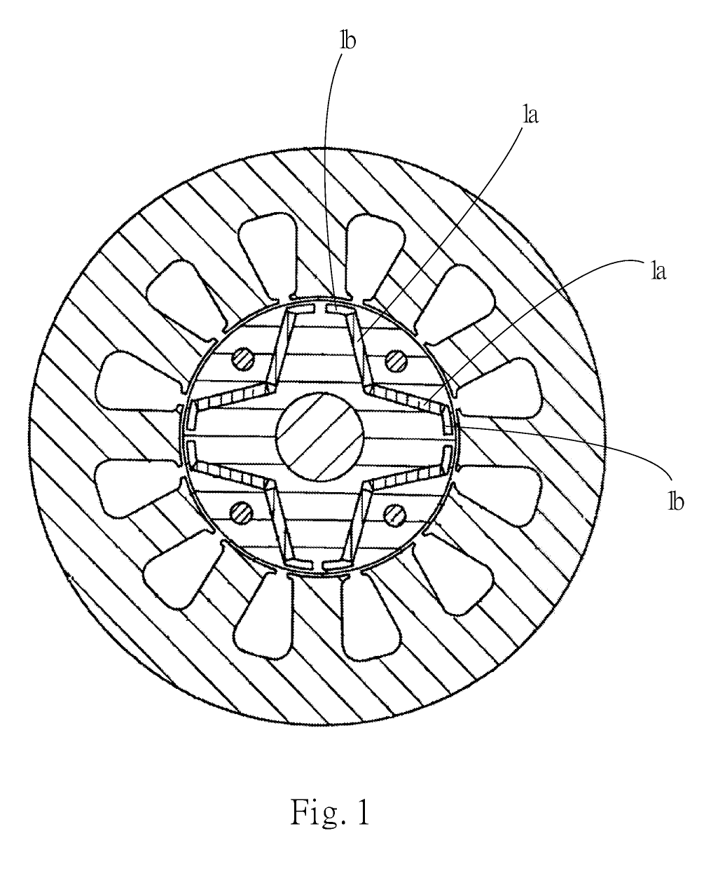

FIG. 2 is a sectional view of another conventional interior-permanent-magnet motor;

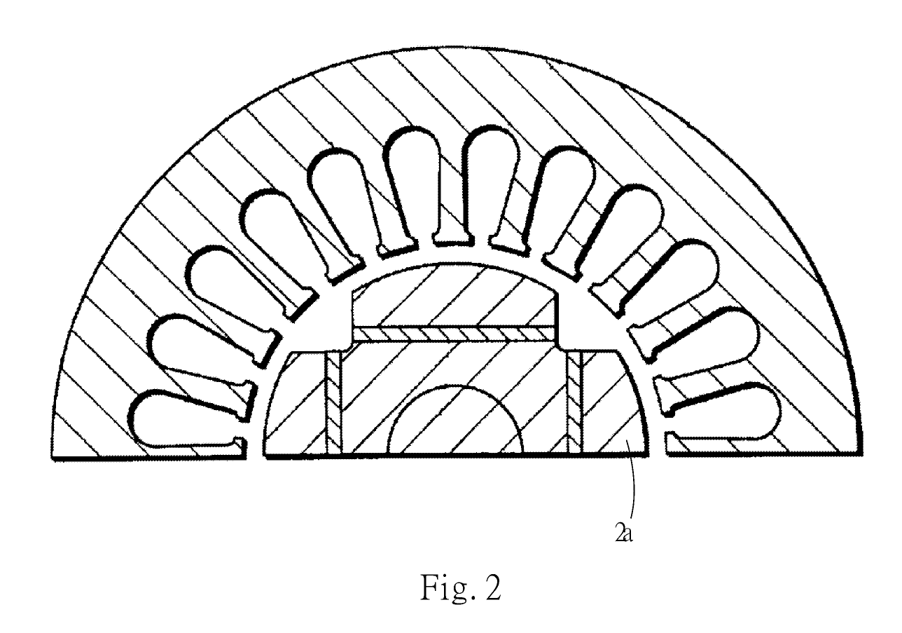

FIG. 3 is a sectional view of still another conventional interior-permanent-magnet motor;

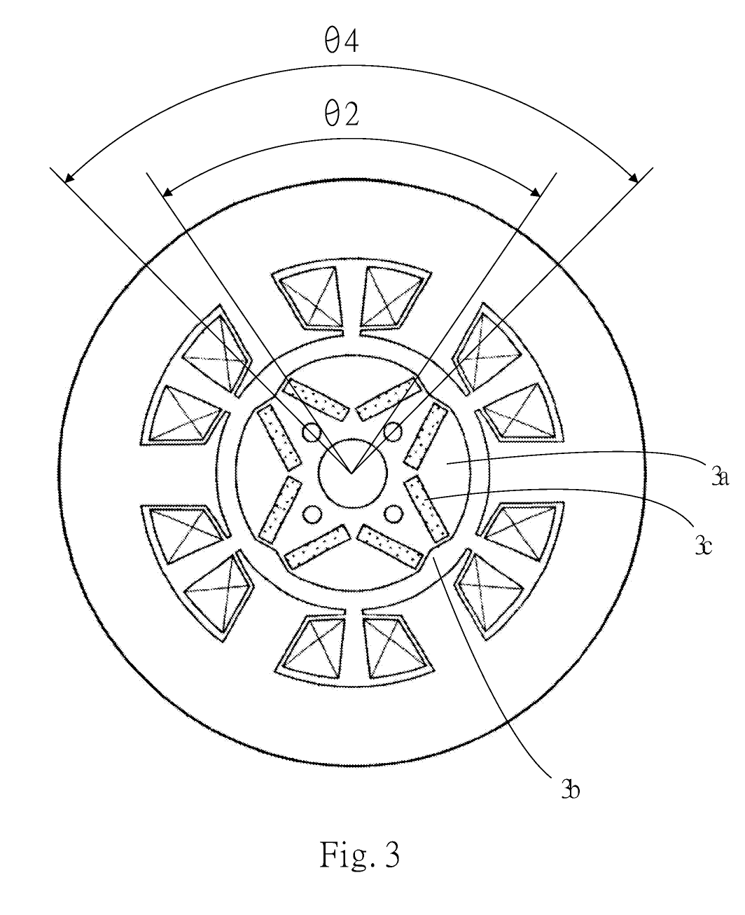

FIG. 4 is a diagram showing the relationship between the notches and the efficiency of the conventional interior-permanent-magnet motor of FIG. 3;

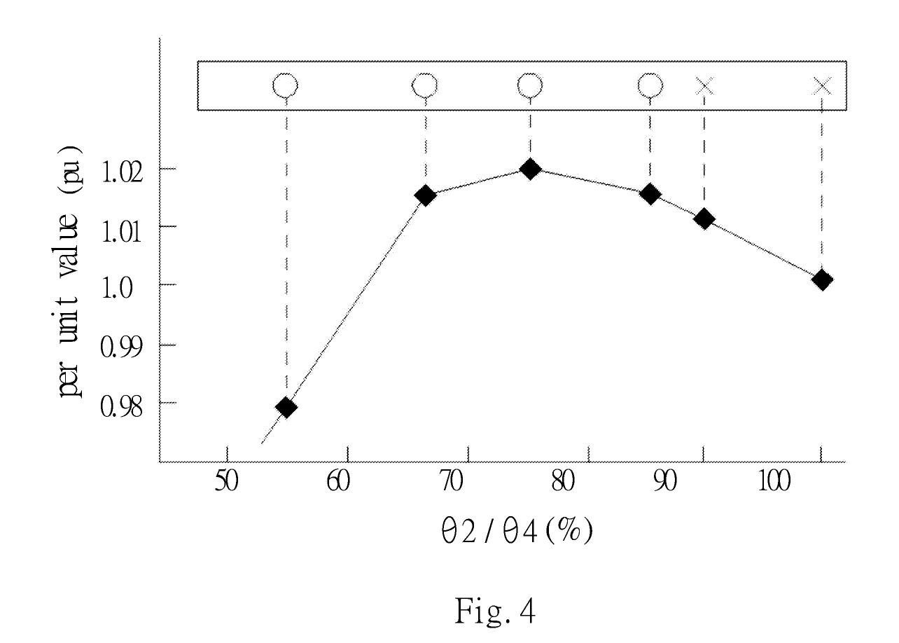

FIG. 5 is a plane view of a preferred embodiment of the present invention;

FIG. 6 is an enlarged view of circled area of FIG. 5; and

FIG. 7 is a cogging force rotational torque-time curve diagram of the preferred embodiment of the present invention.

### DETAILED DESCRIPTION OF THE PREFERRED EMBODIMENTS

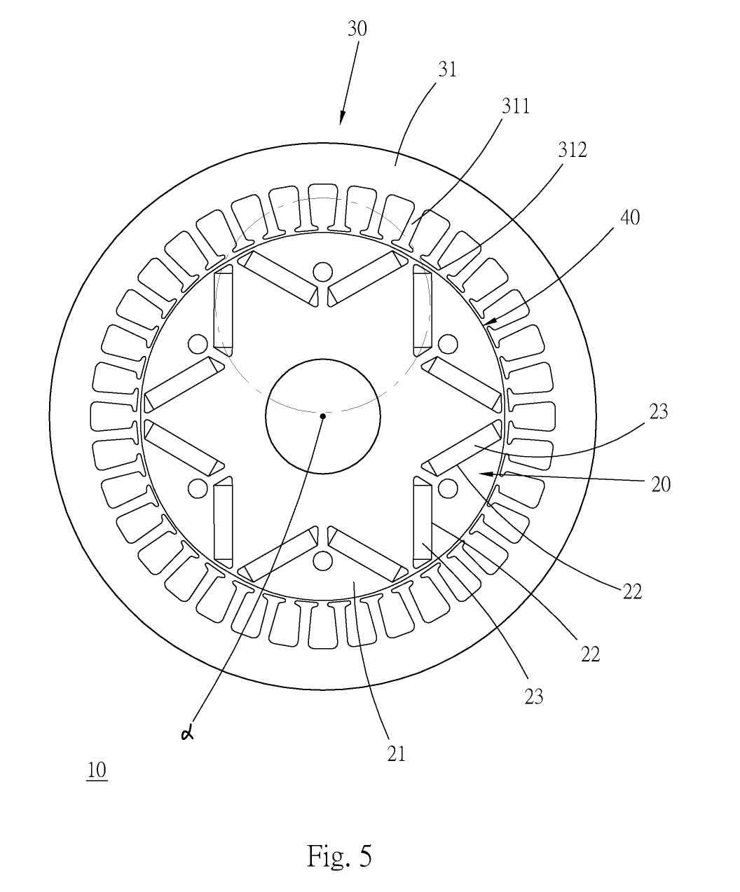

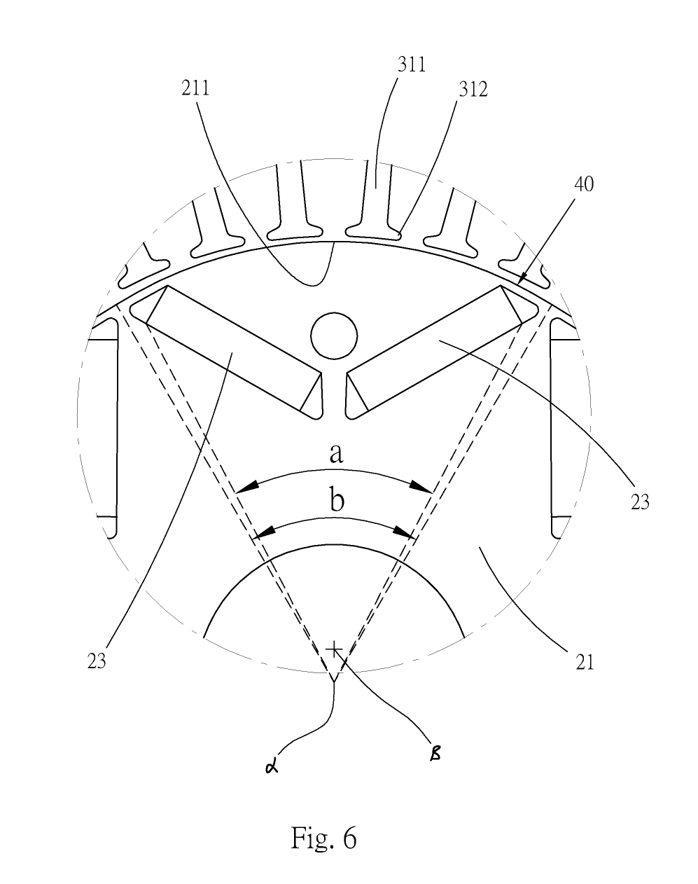

Please refer to FIGS. 5 and 6. According to a preferred embodiment, the interior-permanent-magnet motor structure 10 of the present invention is an interior-permanent-magnet motor with improved air gap space based on the conventional V-shaped interior-permanent-magnet motor. The interior-permanent-magnet motor structure 10 includes a rotor member 20, a stator member 30 and an annular air gap 40.

The rotor member 20 has a rotor seat 21. Multiple insertion cavities 22 with elongated cross section are respectively disposed in the rotor seat 21 in pair. The insertion cavities 22 are lengthwise arranged in V-form. The opening of the V-form is positioned with its back to the curvature center α of the rotor seat 21. Multiple magnetic bodies 23 with elongated cross section are respectively inlaid in the insertion cavities 22. The volume of the magnetic body 23 is smaller than the capacity of the insertion cavity in which the magnetic body is inlaid. Two ends of the magnetic body 23 are spaced from the walls of two ends of the insertion cavity 22, whereby two voids are formed at two ends of the magnetic body 23 so as to adjust the magnetic flux density of the magnetic body 23.

The stator member 30 has a hollow annular stator seat 31. The stator seat 31 is coaxially fitted around the rotor seat 21. Multiple distributed windings (not shown) are respectively wound on multiple pole cores 311 of the stator seat 31. Each pole core 311 has a free end formed with a pole paw 312 having a paw face. The paw faces of the pole paws 312 together form an inner circumference of the stator seat 31. In other words, the inner circumference of the stator seat 31 is formed of multiple discontinuous paw faces.

The air gap 40 has the form of an annular band and is positioned between the outer circumference of the rotor seat 21 and the inner circumference of the stator seat 31. The annular band of the air gap 40 has a non-uniform width. The width of the annular band of the air gap 40 has a maximum value g and a minimum value gₘᵢₙ within the range of each pole pitch. The ratio of the maximum value g to the minimum value gₘᵢₙ meets the following formula:

gₘᵢₙ÷g=cos(b÷a×θ), wherein:

gₘᵢₙ is the minimum value of the width of the annular band of the air gap 40, g is the maximum value of the width of the annular band of the air gap 40, a is the magnetic flare angle, that is, the angle defined by two points of a pair of magnetic bodies 23 that are spaced from each other by a linear largest distance and the curvature center of the rotor seat as an original point, b is the pole pitch, and θ is −π÷2˜+π÷2.

Substantially, in this embodiment, the values of the respective parameters are:

a=55; and

b=60.

According to the above formula, gₘᵢₙ÷g=0.42.

To speak more specifically, in this embodiment, the change of the width of the annular band of the air gap 40 is achieved in such a manner that the inner circumference of the stator seat 31 has an annular form with a curvature center coaxial with the curvature center of the rotor seat 21. The curvatures of the arc faces 211 of the outer circumference of the rotor seat 21 corresponding to the respective pole pitch ranges are different from the circular curvature centered at the curvature center α of the rotor seat 21. Accordingly, the curvature center β of the arc faces 211 within each pole pitch range is different from the curvature center α of the rotor seat and positioned between the curvature center α of the rotor seat and the belonging arc faces 211. In this case, relative to the circular face centered at the curvature center α of the rotor seat, the respective arc faces 211 are in the form of protuberances. The highest point of the protuberance is positioned at the center of the belonging pole pitch, where the minimum width of the annular band of the air gap is positioned.

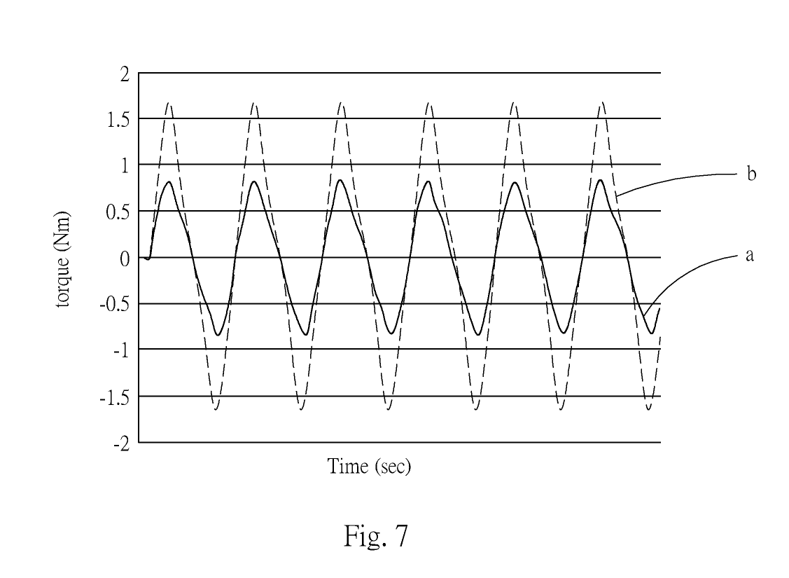

According to the above arrangement, in the interior-permanent-magnet motor structure 10 of the present invention, the width of the annular band of the air gap is changed to vary the air gap space through which the magnetic path passes along with the operation of the rotor. Accordingly, the air gap magnetic flux is changed from square wave into sine wave. In this case, the cogging force rotational torque can be greatly reduced to achieve a relatively gentle cogging force rotational torque curve a as shown in FIG. 7. In comparison with the cogging force rotational torque curve b of the conventional technique, the cogging force rotational torque of the interior-permanent-magnet motor structure 10 can be reduced by about 50% to greatly enhance the stability of operation.

Furthermore, in comparison with the conventional technique, in manufacturing of the interior-permanent-magnet motor structure 10, it is only necessary to modify the arc of the outer circumference of the rotor seat 21 so that the interior-permanent-magnet motor structure 10 can be very easily manufactured and processed with a high precision. In view of the commercialization of the interior-permanent-magnet motor structure 10, the interior-permanent-magnet motor structure 10 has the advantages of low cost, high precision and easy processing.

The above embodiments are only used to illustrate the present invention, not intended to limit the scope thereof. Many modifications of the above embodiments can be made without departing from the spirit of the present invention.

What is claimed is:

1. An interior-permanent-magnet motor structure comprising:
a rotor member having a rotor seat, multiple magnetic bodies being embedded in the rotor seat in pair, the magnetic bodies being arranged in V-form, an opening of the V-form being positioned with its back to a curvature center of the rotor seat;
a stator member having a hollow stator seat, the stator seat being coaxially fitted around the rotor seat; and
an air gap having the form of an annular band, the air gap being positioned between inner circumference of the stator seat and outer circumference of the rotor seat, the interior-permanent-magnet motor structure being characterized in that the width of the annular band of the air gap has a maximum value and a minimum value within each pole pitch, the ratio of the maximum value to the minimum value meeting the following formula: gₘᵢₙ÷g=cos(b÷a×θ), wherein: gₘᵢₙ is the minimum value of the width of the annular band of the air gap, g is the maximum value of the width of the annular band of the air gap, a is the magnetic flare angle, b is the pole pitch, and θ is −π÷2˜+π÷2.

2. The interior-permanent-magnet motor structure as claimed in claim 1, wherein the arc faces of the outer circumference of the rotor seat corresponding to the respective pole pitch ranges have respective curvature centers, the curvature centers of the arc faces being different from the curvature center of the rotor seat.

3. The interior-permanent-magnet motor structure as claimed in claim 2, wherein the curvature centers of the respective arc faces are positioned between the curvature center of the rotor seat and the arc faces.

4. The interior-permanent-magnet motor structure as claimed in claim 3, wherein the curvature center of the inner circumference of the stator seat is coaxial with the curvature center of the rotor seat.

5. The interior-permanent-magnet motor structure as claimed in claim 1, wherein the minimum width of the annular band of the air gap within each pole pitch range is positioned at the center of the belonging pole pitch.

6. The interior-permanent-magnet motor structure as claimed in claim 1, wherein the magnetic flare angle is the angle defined by two points of a pair of magnetic bodies that are spaced from each other by a largest distance and the curvature center of the rotor seat as an original point.

7. The interior-permanent-magnet motor structure as claimed in claim 1, wherein the rotor member further includes multiple insertion cavities respectively disposed in the rotor seat in pair, the multiple magnetic bodies being respectively inlaid in the insertion cavities in pair.

8. The interior-permanent-magnet motor structure as claimed in claim 7, wherein each insertion cavity has a capacity larger than a volume of the magnetic body inlaid in the insertion cavity.

9. The interior-permanent-magnet motor structure as claimed in claim 8, wherein each insertion cavity has an elongated cross section and the walls of two ends of the insertion cavity are spaced from two ends of the magnetic body inlaid in the insertion cavity.

10. The interior-permanent-magnet motor structure as claimed in claim 1, wherein the stator member further includes multiple distributed windings respectively wound on the stator seat.
